(19) United States
(12) Patent Application Publication
(10) Pub. No.: US 2023/0197940 A1
(43) Pub. Date: Jun. 22, 2023

(54) ANODE COMPOSITION, LITHIUM SECONDARY BATTERY ANODE COMPRISING SAME, AND LITHIUM SECONDARY BATTERY COMPRISING ANODE

(71) Applicant: LG ENERGY SOLUTION, LTD., Seoul (KR)

(72) Inventors: Young Jae KIM, Daejeon (KR); Minjin KO, Daejeon (KR); Jaewook LEE, Daejeon (KR)

(73) Assignee: LG ENERGY SOLUTION, LTD., Seoul (KR)

(21) Appl. No.: 17/981,747

(22) Filed: Nov. 7, 2022

(30) Foreign Application Priority Data
Dec. 22, 2021 (KR) 10-2021-0185213

(51) Int. Cl. H01M 4/38; H01M 4/62; H01M 4/04; H01M 50/46; H01M 10/052

(52) U.S. Cl. CPC H01M 4/386; H01M 4/622; H01M 4/0404; H01M 50/46; H01M 10/052; H01M 2004/027

(57) ABSTRACT

An anode composition, a lithium secondary battery anode including the same, a lithium secondary battery including the anode and a method of making the anode composition. The anode composition includes a silicon-containing active material, an anode conductive material and an anode binder. The anode binder includes (a) a main binder comprising an aqueous binder and (b) a secondary binder comprising a rubber-containing binder. The anode binder contains 80 parts by weight or more and 99 parts by weight or less of the main binder and 1 part by weight or more and 20 parts by weight or less of the secondary binder based on 100 parts by weight of the anode binder. The secondary binder comprises 80 parts by weight or more of butadiene (BD) units based on 100 parts by weight of the secondary binder.

### RELATED APPLICATION DATA

The present application claims priority under 35 U.S.C. 119(a) to KR 10-2021-0185213, filed on Dec. 22, 2021 in the Republic of Korea, the content of which is hereby expressly incorporated by reference in its entirety.

### TECHNICAL FIELD

The present application relates to an anode composition, a lithium secondary battery anode comprising the same, a lithium secondary battery comprising the anode and a method of making the same.

### BACKGROUND ART

Due to the rapid increase in the use of fossil fuels, the demand for the use of alternative energy or clean energy is increasing, and as a part of this, the field that is being studied most actively is the field of power generation and power storage using electrochemical reaction.

Currently, a secondary battery may be a representative example of an electrochemical device using such electrochemical energy, and its use area is in a trend of gradually expanding.

As mobile device technology development and demand increase, the demand for secondary batteries as an energy source is also rapidly increasing. Among these secondary batteries, a lithium secondary battery having high energy density and voltage, a long cycle life, and a low self-discharge rate has been commercialized and widely used. Further, research is being actively conducted on a method for manufacturing a high-density electrode having a higher energy density per unit volume as an electrode for such a high-capacity lithium secondary battery.

In general, a secondary battery includes a cathode, an anode, an electrolyte, and a separator. The anode comprises an anode active material for intercalating and deintercalating lithium ions coming out from the cathode, and silicon-containing particles having a large discharge capacity may be used as the anode active material.

In particular, according to the recent demand for high-density energy batteries, research on a method of increasing the capacity by using as an anode active material a silicon-containing compound together such as Si/C or SiOₓ, which has a capacity 10 times or more larger than that of a graphite-containing material, is being actively conducted. However, in the case of a silicon-containing compound, which is a high-capacity material, compared to graphite that has conventionally been used, there is a problem in that the capacity is large, but the volume rapidly expands during the charging process so that the conductive path is cut off to deteriorate the battery properties.

Therefore, in order to solve a problem when using the silicon-containing compound as an anode active material, methods of suppressing the volume expansion itself such as a method of controlling the driving potential, a method of additionally further coating a thin film on the active material layer and a method of controlling the particle diameter of the silicon-containing compound, or various methods for preventing the conduction path from being cut off are being discussed. However, in the case of the above methods, since the performance of the battery may be rather deteriorated, there is a limit to the application, and there is still a limit to the commercialization of manufacturing an anode battery having a high content of the silicon-containing compound.

In particular, research on the composition of the binder according to volume expansion has also been conducted, and research is underway to use binder polymers with strong stress on the side in order to suppress volume expansion caused by charging and discharging of an anode active material having a large volume change. However, these binder polymers alone have had a limit in suppressing the thickness increase of the electrode due to the contraction and expansion of the anode active material and the performance deterioration of the lithium secondary battery derived therefrom.

Further, in order to solve problems due to volume expansion of an anode having the silicon-containing active material as described above, an aqueous binder having dispersibility and adhesiveness at the same time is used. In the case of the aqueous binder, there is an advantage in that dispersibility can be improved, but since adhesion is lowered, problems such as electrode detachment phenomenon, or the like, due to volume expansion of the active material occur.

In addition, a rubber-containing binder may also be applied in order to improve adhesion. However, in the case of a silicon-containing active material, when a rubber-containing binder is included, a problem of dispersibility occurs, which is also known to have limitations.

Therefore, even when a high-capacity material is used in order to manufacture a high-capacity battery, it is necessary to study a binder that not only does not cause disconnection of the conductive network due to volume expansion of the active material, but also has excellent adhesion.

### PRIOR ART DOCUMENTS

### Patent Documents

(Patent Document 1) Japanese Patent Laid-Open Publication No. 2009-080971

### SUMMARY OF THE INVENTION

The present application relates to an anode composition, a lithium secondary battery anode comprising the same, a lithium secondary battery comprising the anode, and a method of making the anode composition.

An embodiment of the present specification provides an anode composition comprising: a silicon-containing active material; an anode conductive material; and an anode binder, wherein the anode binder comprises a main binder comprising (a) an aqueous binder and (b) a secondary binder comprising a rubber-containing binder, the anode binder contains 80 parts by weight or more and 99 parts by weight or less of the main binder and 1 part by weight or more and 20 parts by weight or less of the secondary binder based on 100 parts by weight of the anode binder, and the secondary binder comprises 80 parts by weight or more of butadiene (BD) units based on 100 parts by weight of the secondary binder.

In another embodiment, there is provided a lithium secondary battery anode comprising: an anode current collector layer; and an anode active material layer containing an anode composition according to the present application formed on one or both surfaces of the anode current collector layer.

In yet another embodiment, there is provided a lithium secondary battery comprising: a cathode; a lithium secondary battery anode according to the present application; a separator provided between the cathode and the anode; and an electrolyte.

### Advantageous Effects

The anode composition according to an embodiment of the present disclosure is characterized in that when a silicon-containing active material, which is a high-capacity material, is used in order to manufacture a high-capacity battery, a problem caused by volume expansion of the silicon-containing active material may be solved by applying a specific anode binder.

In particular, the anode binder comprises (a) a main binder comprising an aqueous binder and (b) a secondary binder comprising a rubber-containing binder, the anode binder contains 80 parts by weight or more and 99 parts by weight or less of the main binder and 1 part by weight or more and 20 parts by weight or less of the secondary binder based on 100 parts by weight of the anode binder, and contains 80 parts by weight or more of butadiene (BD) units based on 100 parts by weight of the secondary binder.

In one embodiment, the main binder is a polymer chain and acts as a matrix, and the secondary binder is in a form of particles and are present within the matrix of the main binder.

Specifically, the anode composition according to the present application can improve dispersibility for dispersing the active material through the main binder even when a silicon-containing active material is used, and can also solve the problem of the conductive network disconnection due to the initial and late adhesion and volume expansion of the battery using the silicon-containing active material by comprising a secondary binder of a specific composition in order to improve adhesion.

That is, the anode composition according to the present application has a sufficient content of silicon-containing active material particles to enable a high-capacity and high-density anode to be obtained, and at the same time, in order to solve a problem such as volume expansion or the like due to having the content of the silicon-containing active material particles, it is the main object of the present disclosure that the above problem has been solved by using an anode binder having a specific composition and content.

### BRIEF DESCRIPTION OF THE DRAWINGS

FIG. 1A is a diagram illustrating a laminated structure of a lithium secondary battery anode according to an embodiment of the present application.

FIG. 1B is a diagram illustrating a laminated structure of a lithium secondary battery anode according to another embodiment of the present application.

FIG. 2 is a diagram illustrating a laminated structure of a lithium secondary battery according to an embodiment of the present application.

### DETAILED DESCRIPTION

Before describing the present disclosure, some terms are first defined.

In the present specification, if a prescribed part “includes” a prescribed element, this means that another element can be further included instead of excluding other elements unless any particularly opposite description exists. In the present specification, ‘p to q’ means a range of ‘p or more and q or less’.

In the present specification, “a specific surface area” is one measured by the BET method, and is specifically calculated from the nitrogen gas adsorption amount under liquid nitrogen temperature (77 K) using BEL Japan's BELSORP-mino II.

That is, the BET specific surface area in the present application may mean a specific surface area measured by the above measurement method.

In the present specification, “Dn” refers to a particle size distribution, and refers to a particle diameter at an n % point of the cumulative distribution of the number of particles according to the particle diameter. That is, D50 is the particle diameter (average particle diameter) at a 50% point of the cumulative distribution of the number of particles according to the particle diameter, D90 is the particle diameter at a 90% point of the cumulative distribution of the number of particles according to the particle diameter, and D10 is the particle diameter at a 10% point of the cumulative distribution of the number of particles according to the particle diameter. Meanwhile, the particle size distribution may be measured using a laser diffraction method.

Specifically, after dispersing a measurement target powder in a dispersion medium, it is introduced into a commercially available laser diffraction particle size measuring device (e.g., Microtrac S3500) to calculate the particle size distribution by measuring the diffraction pattern difference according to the particle size when the particles pass through the laser beam.

In the present specification, the meaning that a polymer comprises a certain monomer as a monomer unit means that the monomer participates in a polymerization reaction and is contained as a repeating unit in the polymer. In the present specification, when it is said that the polymer comprises a monomer, this is interpreted the same as that the polymer comprises the monomer as a monomer unit.

In the present specification, the term ‘polymer’ is understood to be used in a broad sense comprising a copolymer unless specified as a ‘homopolymer’.

In the present specification, the weight average molecular weight (Mw) and the number average molecular weight (Mn) are a polystyrene conversion molecular weight obtained by allowing a monodisperse polystyrene polymer (standard sample) of various polymerization degrees commercially available for molecular weight measurement as a standard material to be measured by gel permeation chromatography (GPC). In the present specification, the molecular weight means a weight average molecular weight unless otherwise specified.

Hereinafter, the present disclosure will be described in detail with reference to the drawings so that those of ordinary skill in the art to which the present disclosure pertains can easily practice the present disclosure. However, the present disclosure may be embodied in various different forms and is not limited to the description below.

An embodiment of the present specification provides an anode composition comprising: a silicon-containing active material; an anode conductive material; and an anode binder, wherein the anode binder comprises (a) a main binder comprising an aqueous binder and (b) a secondary binder comprising a rubber-containing binder, the anode binder contains 80 parts by weight or more and 99 parts by weight or less of the main binder and 1 part by weight or more and 20 parts by weight or less of the secondary binder based on 100 parts by weight of the anode binder, and the secondary binder comprises 80 parts by weight or more of butadiene (BD) units based on 100 parts by weight of the secondary binder.

The anode composition according to an embodiment of the present disclosure can improve dispersibility for dispersing the active material through the main binder even when a silicon-containing active material is used, and can also solve a problem of the conductive network disconnection due to the initial and late adhesion and volume expansion of the battery using the silicon-containing active material by comprising a secondary binder of a specific composition in order to improve adhesion.

In an embodiment of the present application, the silicon-containing active material may comprise one or more selected from the group consisting of Si particles (e.g., SiOₓ, wherein x=0), SiOₓ (0<x<2), SiC, and an Si alloy.

The active material of the present disclosure comprises a silicon-containing active material. The silicon-containing active material may be SiOₓ, Si/C, or Si. SiOₓ may comprise a compound represented by SiOₓ (0≤x<2). In the case of SiO₂, since it does not react with lithium ions so that lithium cannot be stored, x is preferably within the above range. The silicon-containing active material may be Si/C or Si composed of a composite of Si and C. Further, two or more types of the silicon-containing active material may be mixed and used. The anode active material may further comprise a carbon-containing active material together with the aforementioned silicon-containing active material. The carbon-containing active material may contribute to excellent cycle characteristics or the improvement of battery lifespan performance of the anode or secondary battery of the present disclosure.

In general, silicon-containing active materials are known to have a capacity 10 times or more higher than that of carbon-containing active materials, and accordingly, when the silicon-containing active materials are applied to anodes, it is expected that electrodes with a high level of energy density can be realized even with a thin thickness.

In an embodiment of the present application, there is provided an anode composition in which the silicon-containing active material comprises one or more selected from the group consisting of SiOₓ (x=0) and SiOₓ (0<x<2), and SiO_{X} (x=0) is present in an amount of 70 parts by weight or more based on 100 parts by weight of the silicon-based active material. In another embodiment, the silicon-containing active material may comprise SiOₓ (x=0) in an amount of 70 parts by weight or more, preferably 80 parts by weight or more, and more preferably 90 parts by weight or more, and may comprise it in an amount of 100 parts by weight or less, preferably 99 parts by weight or less, and more preferably 95 parts by weight or less based on 100 parts by weight of the silicon-based active material.

The silicon-containing active material according to the present application comprises 70 parts by weight or more of the SiOₓ (x=0) based on 100 parts by weight of the silicon-containing active material, and when compared with the silicon-containing active material using an SiOₓ (0<x<2)-containing active material as a main material, it has a disadvantage in that the theoretical capacity is much lower than that of the silicon-containing active material of the present application. That is, in the case of using the SiOx (0<x<2)-containing active material, no matter what treatment is performed on the active material itself, conditions equivalent to charge and discharge capacity cannot be implemented compared with the case of having the silicon-containing active material of the present disclosure.

In an embodiment of the present application, pure silicon (Si) in the silicon-containing active material may be used as the silicon-containing active material. Using pure silicon (Si) as the silicon-containing active material may mean comprising pure Si particles (SiOₓ (x=0)) that are not combined with other particles or elements in the above range when the total amount of the silicon-containing active material is based on 100 parts by weight as described above.

When comparing the silicon-containing active material with the graphite-containing active material that has conventionally been used, it has a significantly high capacity so that attempts to apply it are increasing, but the volume expansion rate is high in the charging and discharging process so that it is limited to the case or the like of using a small amount mixed with the graphite-containing active material and used.

Therefore, the present disclosure is characterized in that, while using a sufficiently high content of the silicon-containing active material as an anode active material in order to improve capacity performance, a binder solution under specific conditions is used in order to solve problems of maintaining the conductive path due to the volume expansion as described above and maintaining bonding of the conductive material, the binder, and the active material.

Meanwhile, the silicon-containing active material of the present disclosure may have an average particle diameter (D50) of 5 μm to 10 pm, specifically 5.5 μm to 8 pm, and more specifically 6 pm to 7 pm. When the average particle diameter is included in the above range of 5 μm to 10 μm, the specific surface area of the particles is included in a suitable range so that the viscosity of an anode slurry is formed in an appropriate range. Accordingly, the dispersion of the particles constituting the anode slurry is facilitated. Further, since the size of the silicon-containing active material has a value greater than or equal to the lower limit value range, the contact area between the silicon particles and the conductive materials is excellent due to a composite consisting of the conductive material and the binder in the anode slurry, and the possibility that the conductive network will continue increases so that the capacity retention rate is increased. On the other hand, when the average particle diameter satisfies the above range of 5 μm to 10 pm, excessively large silicon particles are excluded to form a smooth surface of the anode, thereby enabling a current density non-uniformity phenomenon to be prevented during charging and discharging.

In an embodiment of the present application, the silicon-containing active material generally has a characteristic BET specific surface area. The silicon-containing active material has a BET specific surface area of preferably 0.01 m²/g to 150.0 m²/g, more preferably 0.1 m²/g to 100.0 m²/g, particularly preferably 0.2 m²/g to 80.0 m²/g, and most preferably 0.2 m²/g to 18.0 m²/g. The BET specific surface area is measured in accordance with DIN 66131 using nitrogen.

In an embodiment of the present application, the silicon-containing active material may exist in, for example, a crystalline or amorphous form, and is preferably not porous. The silicon particles are preferably spherical or fragmented particles. As an alternative but less preferably, the silicon particles may also have a fiber structure or exist in the form of a silicon-containing film or coating.

In an embodiment of the present application, there is provided an anode composition in which the silicon-containing active material is present in an amount of 60 parts by weight or more based on 100 parts by weight of the anode composition.

In another embodiment, the silicon-containing active material may be present in an amount of 60 parts by weight or more, preferably 65 parts by weight or more, and more preferably 70 parts by weight or more, and may be present in an amount of 95 parts by weight or less, preferably 90 parts by weight or less, and more preferably 85 parts by weight or less based on 100 parts by weight of the anode composition.

The anode composition according to the present application does not deteriorate the performance of the anode even when containing the silicon-containing active material in the above range, and has excellent output characteristics in charging and discharging by using specific conductive material and binder capable of holding the volume expansion rate in the charging and discharging process even when a silicon-containing active material having a remarkably high capacity is used in the above range.

In an embodiment of the present application, the silicon-containing active material may have a non-spherical shape, and its circularity is, for example, 0.9 or less, for example, 0.7 to 0.9, for example, 0.8 to 0.9, and for example, 0.85 to 0.9.

In the present application, the circularity is determined by Equation 1-1 below, A is an area, and P is a boundary line.

4πA/P² [Equation 1-1]

Conventionally, it has been common to use only a graphite-containing compound as an anode active material, but recently, as the demand for high-capacity batteries increases, attempts to mix and use a silicon-containing compound in order to increase capacity are increasing. However, in the case of the silicon-containing compound, even if the properties of the silicon-containing active material itself are adjusted according to the present application as described above, the volume rapidly expands during the charging/discharging process so that a problem of damaging a conductive path formed in the anode active material layer may be partially occurred.

Accordingly, in an embodiment of the present application, the anode conductive material may comprise one or more selected from the group consisting of a dot type conductive material, a planar conductive material, and a linear conductive material.

In an embodiment of the present application, the dot type conductive material may be used in order to improve conductivity in the anode, and refers to a dot type or sphere type conductive material having conductivity without causing a chemical change. Specifically, the dot type conductive material may be at least one selected from the group consisting of natural graphite, artificial graphite, carbon black, acetylene black, Ketjen black, channel black, furnace black, lamp black, thermal black, conductive fiber, fluorocarbon, aluminum powder, nickel powder, zinc oxide, potassium titanate, titanium oxide, and polyphenylene derivatives, and may preferably comprise carbon black in the aspects of realizing high conductivity and obtaining excellent dispersibility.

In an embodiment of the present application, the dot type conductive material may have a BET specific surface area of 40 m²/g or more and 70 m²/g or less, preferably 45 m²/g or more and 65 m²/g or less, and more preferably 50 m²/g or more and 60 m²/g or less.

In an embodiment of the present application, the dot type conductive material may satisfy a functional group content (volatile matter) of 0.01% or more and 1% or less, preferably 0.01% or more and 0.3% or less, and more preferably 0.01% or more and 0.1% or less.

In particular, when the functional group content of the dot type conductive material satisfies the above range of 0.01% or more and 1% or less, functional groups exist on the surface of the dot type conductive material so that when water is used as a solvent, the dot type conductive material may be smoothly dispersed in the solvent. In particular, as silicon particles and a specific binder are used in the present disclosure, the functional group content of the dot type conductive material may be lowered, and thus, the present disclosure has an excellent effect on improving dispersibility.

In an embodiment of the present application, it is characterized in that a dot type conductive material having a functional group content in the above range along with the silicon-containing active material is present, and the control of the functional group content may be adjusted depending on the degree of heat treatment of the dot type conductive material.

In an embodiment of the present application, the dot type conductive material may have a particle diameter of 10 nm to 100 nm, preferably 20 nm to 90 nm, and more preferably 20 nm to 60 nm.

In an embodiment of the present application, the conductive material may comprise a planar conductive material.

The planar conductive material may serve to improve conductivity by increasing surface contact between silicon particles in the anode and suppress the disconnection of the conductive path due to volume expansion at the same time. The planar conductive material may be expressed as a plate-shaped conductive material or a bulk-type conductive material.

In an embodiment of the present application, the planar conductive material may bound to the surface of the silicon-containing particles. For example, —OH or —O groups on the surface of the silicon-containing particles may be bonded with the hydrophilic group of the planar conductive materials.

In an embodiment of the present application, the planar conductive material may comprise at least one selected from the group consisting of plate-shaped graphite, graphene, graphene oxide, and graphite flakes, and may preferably be plate-shaped graphite.

In an embodiment of the present application, the planar conductive material may have an average particle diameter (D50) of 2 μm to 7 μm, specifically 3 μm to 6 μm, and more specifically 3.5 μm to 5 μm. When the above range of 2 μm to 7 μm is satisfied, dispersion is easy without causing an excessive increase in the viscosity of the anode slurry based on a sufficient particle size. Therefore, the dispersion effect is excellent when performing dispersion using the same equipment and time.

In an embodiment of the present application, there is provided an anode composition in which the planar conductive material has a D10 of 0.5 μm or more and 2.0 μm or less, a D50 of 2.5 μm or more and 3.5 μm or less, and a D90 of 6.5 μm or more and 15.0 μm or less.

In an embodiment of the present application, the planar conductive material may comprise: a high specific surface area planar conductive material having a high BET specific surface area; or a low specific surface area planar conductive material.

In an embodiment of the present application, the planar conductive material may comprise: a high specific surface area planar conductive material; or a low specific surface area planar conductive material without limitation, but in particular, since the planar conductive material according to the present application may be affected by dispersion to some extent in electrode performance, it may be particularly preferable to use a low specific surface area planar conductive material that does not cause a problem in dispersion.

In an embodiment of the present application, the planar conductive material may have a BET specific surface area of 1 m²/g or more.

In another embodiment, the planar conductive material may have a BET specific surface area of 1 m²/g or more and 500 m²/g or less, preferably 5 m²/g or more and 300 m²/g or less, and more preferably 5 m²/g or more and 250 m²/g or less.

The planar conductive material according to the present application may comprise: a high specific surface area planar conductive material; or a low specific surface area planar conductive material.

In another embodiment, the planar conductive material may be a high specific surface area planar conductive material, and may satisfy a BET specific surface area range of 50 m²/g or more and 500 m²/g or less, preferably 80 m²/g or more and 300 m²/g or less, and more preferably 100 m²/g or more and 300 m²/g or less.

In another embodiment, the planar conductive material may be a low specific surface area planar conductive material, and may satisfy a BET specific surface area range of 1 m²/g or more and 40 m²/g or less, preferably 5 m²/g or more and 30 m²/g or less, and more preferably 5 m²/g or more and 25 m²/g or less.

Other conductive materials may comprise linear conductive materials such as carbon nanotubes, etc. The carbon nanotubes may be bundle type carbon nanotubes. The bundle type carbon nanotubes may comprise a plurality of carbon nanotube units. Specifically, herein, the term ‘bundle type’ refers to, unless otherwise stated, a secondary shape in the form of a bundle or rope, in which a plurality of carbon nanotube units are arranged side by side or entangled so that the axes of the carbon nanotube units in the longitudinal direction are in substantially the same orientation. The carbon nanotube units have a graphite sheet in the form of a cylinder having a nano-size diameter, and have a sp2 bond structure. At this time, the carbon nanotube units may exhibit properties of a conductor or a semiconductor depending on the angle and structure at which the graphite sheet is rolled. The bundle type carbon nanotubes may be uniformly dispersed during the manufacturing of the anode compared to the entangled type carbon nanotubes, and may smoothly form the conductive network in the anode, thereby enabling conductivity of the anode to be improved. Illustratively, a linear conductive material may be a single walled carbon nanotube (SWCNT), which has a large BET specific surface area, a linear shape, a very small diameter, and a very long length. It is not possible to elongate a linear conductive material such as a SWCNT through dispersion, and it has a strong ability to return to its original shape as it dries. As a result, a linear conductive material such as a SWCNT usually exist in the form of wrapping or connecting active materials or secondary aggregates because they have a strong force to return to their original form as they dry. The bonding method is adsorbed by van der Waals force.

In an embodiment of the present application, there is provided an anode composition in which the anode conductive material is present in an amount of 10 parts by weight or more and 40 parts by weight or less based on 100 parts by weight of the anode composition.

In another embodiment, the anode conductive material may be present in an amount of 10 parts by weight or more and 40 parts by weight or less, preferably 10 parts by weight or more and 30 parts by weight or less, and more preferably 10 parts by weight or more and 25 parts by weight or less based on 100 parts by weight of the anode composition.

In an embodiment of the present application, there is provided an anode composition in which the anode conductive material comprises: a planar conductive material; and a linear conductive material.

In an embodiment of the present application, there is provided an anode composition in which the anode conductive material comprises 80 parts by weight or more and 99.9 parts by weight or less of the planar conductive material; and 0.1 parts by weight or more and 20 parts by weight or less of the linear conductive material based on 100 parts by weight of the anode conductive material.

In another embodiment, the anode conductive material may comprise the planar conductive material in an amount of 80 parts by weight or more and 99.9 parts by weight or less, preferably 85 parts by weight or more and 99.9 parts by weight or less, and more preferably 95 parts by weight or more and 98 parts by weight or less based on 100 parts by weight of the anode conductive material.

In another embodiment, the anode conductive material may comprise the linear conductive material in an amount of 0.1 parts by weight or more and 20 parts by weight or less, preferably 0.1 parts by weight or more and 15 parts by weight or less, and more preferably 2 parts by weight or more and 5 parts by weight or less based on 100 parts by weight of the anode conductive material.

In an embodiment of the present application, as the anode conductive material comprises a planar conductive material and a linear conductive material, and satisfies each of the compositions and ratios, the lifespan characteristics of an existing lithium secondary battery are not significantly affected. In particular, when the planar conductive material and the linear conductive material are included, the number of points enabling charging and discharging increases so that the output characteristics are excellent at a high C-rate and characteristics of reducing the amount of high-temperature gas generation are obtained.

The anode conductive material according to the present application has a configuration completely different from the cathode conductive material applied to the cathode. That is, the anode conductive material according to the present application is one which serves to hold the contact point between silicon-containing active materials having a very large volume expansion of the electrode by charging and discharging, and the cathode conductive material serves as a buffer of a buffering role when rolled and serves to impart some conductivity, and has a completely different configuration and role from the anode conductive material of the present disclosure.

Further, the anode conductive material according to the present application is applied to the silicon-containing active material, and has a configuration completely different from a conductive material applied to a graphite-containing active material. That is, since the conductive material used in an electrode having the graphite-containing active material simply has small particles compared to the active material, it has the characteristics of improving output characteristics and imparting some conductivity, and the configuration and role thereof are completely different from those of the anode conductive material applied along with the silicon-containing active material as in the present disclosure.

In an embodiment of the present application, the planar conductive material used as the above-described anode conductive material has structure and role different from those of the carbon-containing active material generally used as the anode active material. Specifically, the carbon-containing active material used as the anode active material may be artificial graphite or natural graphite, and refers to a material that is processed into the form of a sphere or dot and used in order to facilitate storage and release of lithium ions.

On the other hand, the planar conductive material used as the anode conductive material is a material having a plane or plate shape, and may be expressed as plate-shaped graphite. That is, the planar conductive material is a material present in order to maintain a conductive path in the anode active material layer, and it does not mean a material which plays a role of storage and release of lithium, but means a material for securing a conductive path in a planar shape inside the anode active material layer.

That is, in the present application, the fact that plate-shaped graphite has been used as a conductive material means that it has been processed into a planar shape or a plate shape and used as a material that secures a conductive path, not a role of storing or releasing lithium. At this time, the anode active material contained together has high capacity characteristics for lithium storage and release, and plays a role capable of storing and releasing all lithium ions transferred from the cathode.

Meanwhile, in the present application, the fact that the carbon-containing active material has been used as an active material means that it has been processed into a dot shape or a spherical shape and used as a material that plays a role of storing or releasing lithium.

In an embodiment of the present application, there is provided an anode composition in which the anode binder comprises (a) a main binder comprising an aqueous binder and (b) a secondary binder comprising a rubber-containing binder, comprises 85 parts by weight or more and 95 parts by weight or less of the main binder and 5 parts by weight or more and 15 parts by weight or less of the secondary binder based on 100 parts by weight of the anode binder, and comprises 80 parts by weight or more of butadiene (BD) units based on 100 parts by weight of the secondary binder.

In an embodiment of the present application, the anode binder comprises a main binder comprising an aqueous binder. The main binder is one which has dispersibility for dispersing the anode active material in an anode slurry state containing the anode composition and adhesive force for binding with the anode current collector layer and anode active material layer after drying at the same time, and corresponds to a binder in which the adhesive force is not high. That is, the main binder comprising the aqueous binder according to the present application may mean a binder having a surface bonding form.

In an embodiment of the present application, the aqueous binder is one which can be dissolved in an aqueous solvent such as water or the like, and may comprise at least one selected from the group consisting of polyvinyl alcohol (PVA), polyacrylic acid (PAA), polyethylene glycol (PEG), polyacrylonitrile (PAN), and polyacrylamide (PAM). In the aspect of having excellent resistance to volume expansion/contraction of the silicon-containing active material, it may comprise preferably at least one selected from the group consisting of polyvinyl alcohol and polyacrylic acid, more preferably polyvinyl alcohol and polyacrylic acid.

In the aspects of allowing the aqueous binder to be dispersed more well in an aqueous solvent such as water or the like when preparing an anode slurry for forming the anode active material layer, and improving the binding force by coating the active material more smoothly, the aqueous binder may comprise one in which hydrogen in the aqueous binder is substituted with Li, Na, Ca, or the like.

In an embodiment of the present application, the main binder may have a Young's modulus of 0.3×10² MPa or more. In another embodiment, the main binder may have a Young's modulus of 0.3×10² MPa or more, preferably 0.5×10² MPa or more, and more preferably 2×10² MPa or less, preferably 1.5×10² MPa or less, and more It can satisfy 1.3×10² MPa or less.

In the method of measuring the Young's modulus, the main binder solution is put into a coated bowl and dried at room temperature for a long time to remove moisture. The dried film is obtained by vacuum drying at 130° C. for 10 hr in accordance with the electrode drying temperature. After that, the dried film can be cut or punched into a sample form of 6 mm×100 mm to collect a sample, and the tensile strength (Young's modulus) can be measured using UTM equipment.

The Young's modulus of the main binder varies depending on the measurement method, the speed, and the measurement state of the binder, but the Young's modulus of the main binder is a value measured in a dry room with a dew point of −5° C. to 22° C. In the present application, the dew point starts to condense at a certain temperature when the humid air is cooled, and the partial pressure of water vapor in the air is equal to the saturated vapor pressure of water at the temperature. That is, when the temperature of the gas including water vapor is dropped as it is, the relative humidity may be 100% and thus may mean a temperature at which dew starts to form.

The dew point is −5° C. to 10° C., and a temperature of about 20° C. to 22° C. may be generally defined as a dry room, and in this case, the humidity corresponds to a very low level.

In this application, the main binder may be a PAM-based binder, and in this case, the PAM-based binder may be used by adjusting the ratio of PAM, PAA, and PAN, and the composition may be appropriately changed to so that the same Young's modulus can be satisfied.

The aqueous binder has water-friendly characteristics (hydrophilicity), and has properties that it generally does not dissolve in an electrolyte or an electrolytic solution used in a secondary battery. These characteristics can impart strong stress or tensile strength to the aqueous binder when applied to an anode or a lithium secondary battery, thereby enabling the problem of volume expansion/contraction due to charging and discharging of the silicon-containing active material to be effectively suppressed.

In an embodiment of the present application, there is provided an anode composition in which the main binder has a weight average molecular weight of 100,000 g/mol or more and 1,000,000 g/mol or less.

In an embodiment of the present application, the rubber-containing binder is a material different from the aqueous binder, and may be defined as one which is not dissolved well in an aqueous solvent such as water or the like, but can be smoothly dispersed in the aqueous solvent. Specifically, the rubber-containing binder may comprise at least one selected from the group consisting of styrene butadiene rubber (SBR), hydrogenated nitrile butadiene rubber (HNBR), acrylonitrile butadiene rubber, acrylic rubber, butyl rubber, and fluororubber, preferably at least one selected from the group consisting of styrene butadiene rubber and hydrogenated nitrile butadiene rubber in the aspects of easy dispersion and excellent phase stability, and more preferably styrene butadiene rubber.

In an embodiment of the present application, there is provided an anode composition comprising 80 parts by weight or more of butadiene (BD) based on 100 parts by weight of the secondary binder.

In another embodiment, butadiene (BD) may be present in an amount of 80 parts by weight or more, or 81 parts by weight or more, and may satisfy an amount range of 99 parts by weight or less, preferably 90 parts by weight or less based on 100 parts by weight of the secondary binder.

In general, the secondary binder is a material which has very high electrolyte wettability compared to the aqueous binder. When the secondary binder is located near the surface of the silicon-containing anode, the anode resistance is lowered since the FEC solvent or LiPF₆ salt capable of making an SEI layer can be rapidly supplied.

However, the secondary binder according to the present application contains the above amount of butadiene (BD) containing on 100 parts by weight of the secondary binder. An SEI layer is formed on the surface of the anode active material layer depending on the electrolyte, and at this time, the formation of the SEI layer starts from a radical reaction. Butadiene (BD) has a conjugation bond (1.5 bond) in which double bonds and single bonds are rapidly changed, has free radicals present therein, and has high adhesion with an active material.

Therefore, as described in the present application, when butadiene (BD) is present in the above amount based on 100 parts by weight of the secondary binder, an SEI layer is formed by receiving radicals from the butadiene component contained in a specific part by weight, and since this is connected to the secondary binder, a phenomenon that the SEI layer is detached or broken is prevented, thereby having an advantage of not needing to produce an additional SEI layer. Accordingly, the lithium secondary battery has a feature that an increase in the resistance increase rate of the electrode can be further prevented.

In an embodiment of the present application, since the aqueous binder has a strong stress, when only the aqueous binder is used alone, there is a risk of bending phenomenon of the anode, crack occurrence due to the bending, and deterioration of lifespan characteristics. The rubber-containing binder may be well dissolved in an electrolyte or an electrolytic solution generally used in secondary batteries, and when used in combination with an aqueous binder, the stress of the aqueous binder may be relieved to a certain level.

In one embodiment of this application, the secondary binder may have a strain of 30% or more, preferably a strain of 100% or more, more preferably a strain of 150% or more, and most preferably a strain of 200% or more. It is preferable that the strain can be 1000% or less, 900% or less, and more preferably 800% or less.

In this case, the strain value of the secondary binder may be implemented in a range satisfying the above-described range by adjusting the ratio of ST/BD of the SBR binder to an appropriate range.

In the method of measuring the strain, the secondary binder solution is put into a coated bowl and dried at room temperature for a long time to remove moisture. The dried film is obtained by vacuum drying at 130° C. for 10 hr in accordance with the electrode drying temperature. Thereafter, the dried film may be cut or punched into a sample form of 6 mm×100 mm to collect a sample, and a tensile strain may be measured using UTM equipment.

The tensile strain of the secondary binder varies depending on a measurement method, a speed, and a measurement state of the binder, but the strain of the secondary binder is the same as the measurement condition of the Young's modulus in the main binder.

In an embodiment of the present application, the anode binder including the main binder and the secondary binder may have a Young's modulus of 90 MPa or more and 110 MPa or less, and a strain value of 20% or more and 45% or less.

That is, in order to solve the problem of strong stress when only the main binder is used, a secondary binder satisfying the strain value is applied. It has the characteristic of ensuring adhesion force while alleviating it to a certain level.

Therefore, the anode composition of the present disclosure has characteristics capable of enabling the lifespan characteristics to be improved, enabling the warpage problem during manufacturing of a thin film anode to be solved and enabling the adhesive force to be also improved by using an anode binder containing the main binder comprising the aqueous binder and the secondary binder comprising the rubber-containing binder at a specific weight ratio, thereby effectively solving the volume expansion/contraction problem of the silicon-containing active material.

Furthermore, when the anode composition comprises the above-described anode binder, and a planar conductive material and a linear conductive material as an anode conductive material, it has characteristics capable of improving the problem of adhesive force and also improving the internal resistance of the anode at the same time.

In an embodiment of the present application, the anode binder may contain 80 parts by weight or more and 99 parts by weight or less of the main binder and 1 part by weight or more and 20 parts by weight or less of the secondary binder based on 100 parts by weight of the anode binder.

In another embodiment, the anode binder may satisfy an amount range of the main binder of 80 parts by weight or more and 99 parts by weight or less, preferably 87 parts by weight or more and 97 parts by weight or less, and more preferably 89 parts by weight or more and 96 parts by weight or less based on 100 parts by weight of the anode binder.

In another embodiment, the anode binder may contain the secondary binder in an amount of 1 part by weight or more and 20 parts by weight or less, preferably 3 parts by weight or more and 13 parts by weight or less, and more preferably 4 parts by weight or more and 11 parts by weight or less based on 100 parts by weight of the anode binder.

As described above, the anode binder according to the present application is one in which the main binder and the secondary binder satisfy the above contents, and it has characteristics capable of improving dispersibility and also solving the problem of adhesive force even when a silicon-containing active material is used.

In an embodiment of the present application, the anode binder may further comprise at least any one selected from the group consisting of polyvinylidene fluoride-hexafluoropropylene copolymer (PVDF-co-HFP), polyvinylidene fluoride, polyacrylonitrile, polymethylmethacrylate, polyvinyl alcohol, carboxymethyl cellulose (CMC), starch, hydroxypropyl cellulose, regenerated cellulose, polyvinylpyrrolidone, tetrafluoroethylene, polyethylene, polypropylene, polyacrylic acid, ethylene-propylene-diene monomer (EPDM), sulfonated EPDM, styrene butadiene rubber (SBR), fluororubber, polyacrylic acid, and a material in which hydrogens thereof are substituted with Li, Na, or Ca, and may also comprise various copolymers thereof.

In an embodiment of the present application, there is provided anode composition in which the anode binder is present in an amount of 5 parts by weight or more and 30 parts by weight or less based on 100 parts by weight of the anode composition.

In an embodiment of the present application, the anode binder may be present in an amount of 30 parts by weight or less, preferably 25 parts by weight or less, and more preferably 20 parts by weight or less, and may be present in an amount of 5 parts by weight or more, or 10 parts by weight or more based on 100 parts by weight of the anode composition.

When a Si-containing anode is used compared to the conventional carbon-containing anode, the main binder comprising the aqueous binder is applied in an amount of the above parts by weight so that the secondary binder may be used in a certain range. In particular, the content of butadiene in the secondary binder satisfies the above range so that, although the secondary binder with a low content is present, the anode binder has characteristics that the bonding strength with the conductive material/binder becomes excellent.

In an embodiment of the present application, there is provided a lithium secondary battery anode comprising: an anode current collector layer; and an anode active material layer containing the anode composition according to the present application, which is formed on one or both surfaces of the anode current collector layer.

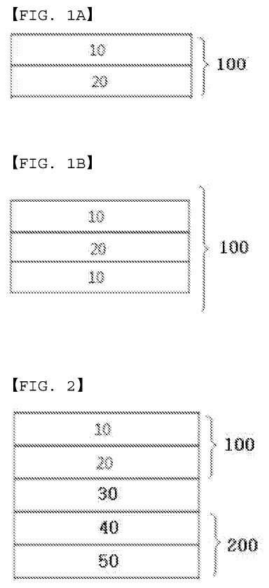

FIG. 1A is a diagram illustrating a laminated structure of a lithium secondary battery anode according to an embodiment of the present application. Specifically, the lithium secondary battery anode 100 comprising the anode active material layer 20 formed on one surface of the anode current collector layer 10 can be confirmed, and FIG. 1A shows that the anode active material layer is formed on one surface of the anode current collector layer. In another embodiment, the lithium secondary battery anode 100 is such that the anode active material layer 20 is formed on both surfaces of the anode current collector 10, as shown in FIG. 1B. Preferably, the anode active material layer 20 is formed on both surfaces of the anode current collector 10.

As discussed above, there are two embodiments, one where the anode active material layer is coated on one side of the anode current collector (as shown in FIG. 1A), and another where the anode active material layer is coated on both sides of the anode current collector layer (as shown in FIG. 1B). The composition of the anode active material layer to be coated on both sides may be the same or different from each other. In one embodiment, if the composition of the anode active material layer is different on each side, a commonly used anode active material layer such as carbon-containing or silicon-containing may be used on one side and the anode active material layer disclosed herein on the other.

In an embodiment of the present application, the anode may form a lithium secondary battery anode by coating the anode slurry containing the anode composition on one or both surfaces of the current collector.

In an embodiment of the present application, the anode slurry may contain: an anode composition; and a slurry solvent.

In an embodiment of the present application, the anode slurry may satisfy a solid content of 5% or more and 40% or less.

In another embodiment, the anode slurry may satisfy a solid content range of 5% or more and 40% or less, preferably 7% or more and 35% or less, and more preferably 10% or more and 30% or less.

The solid content of the anode slurry may mean the amount of the anode composition contained in the anode slurry, and may mean the amount of the anode composition based on 100 parts by weight of the anode slurry.

When the anode slurry satisfies the above solid content range of 5% or more and 40% or less, the anode active material layer has a suitable viscosity during the formation of the anode active material layer so that particle agglomeration phenomenon of the anode composition is minimized to have characteristics capable of efficiently forming the anode active material layer.

In an embodiment of the present application, the anode current collector layer generally has a thickness of 1 μm to 100 μm. Such an anode current collector layer is not particularly limited as long as it is one which has high conductivity without causing a chemical change in the concerned battery, and for example, copper, stainless steel, aluminum, nickel, titanium, calcined carbon, one in which the surface of copper or stainless steel is surface-treated with carbon, nickel, titanium, silver, etc., an aluminum-cadmium alloy, etc. may be used. Further, the anode current collector layer may strengthen the bonding force of the anode active material by forming fine irregularities on its surface, and may be used in various forms such as a film, a sheet, a foil, a net, a porous body, a foam, a nonwoven fabric, etc.

In an embodiment of the present application, there is provided a lithium secondary battery anode in which the anode current collector layer has a thickness of 1 μm or more and 100 μm or less, and the anode active material layer has a thickness of 20 μm or more and 500 μm or less.

However, the thickness may be variously modified depending on the type and use of the anode used, but the present disclosure is not limited thereto.

In an embodiment of the present application, the anode active material layer may satisfy a porosity range of 10% or more and 60% or less.

In another embodiment, the anode active material layer may satisfy a porosity range of 10% or more and 60% or less, preferably 20% or more and 50% or less, and more preferably 30% or more and 45% or less.

The porosity is one which is changed depending on the compositions and contents of: the silicon-containing active material; the conductive material; and the binder contained in the anode active material layer, particularly one which satisfies the above range according as the silicon-containing active material and conductive material according to the present application are contained in specific compositions and amounts, and is characterized in that it has appropriate ranges of electrical conductivity and resistance in the electrode accordingly.

In an embodiment of the present application, there is provided a lithium secondary battery anode in which the surface of the anode active material layer in contact with the anode current collector layer satisfies an adhesive force of 300 gf/5 mm or more and 500 gf/5 mm or less under atmospheric pressure condition at 25° C.

In another embodiment, the surface of the anode active material layer in contact with the anode current collector layer may satisfies an adhesive force of 300 gf/5 mm or more and 500 gf/5 mm or less, preferably 300 gf/5 mm or more and 450 gf/5 mm or less, and more preferably 350 gf/5 mm or more and 430 gf/5 mm or less under atmospheric pressure condition at 25° C.

In particular, the anode according to the present application comprises a specific anode binder as the anode composition described above so that the adhesive force is improved as described above. Further, even when the expansion and contraction of the silicon-containing active material are repeated by repeating charging and discharging of the anode, it has characteristics capable of suppressing an increase in resistance by applying the anode binder and the anode conductive material of specific compositions to maintain the conductive network and prevent disconnection thereof.

The adhesive force is measured at 90° and a rate of 5 mm/s with a peel strength measuring instrument using a 3M 9070 tape. Specifically, one surface of the anode active material layer of the lithium secondary battery anode is adhered to one surface of a slide glass (3M 9070 tape) to which an adhesive film is attached. Thereafter, it is attached by reciprocating a 2 kg rubber roller 5 to 10 times, and the adhesive force (peel force) is measured at a rate of 5 mm/s in an angular direction of 90°. At this time, the adhesive force can be measured at 25° C. and atmospheric pressure conditions.

Specifically, the measurement of the adhesive force is made at 25° C. and atmospheric pressure conditions with respect to a 5 mm×15 cm electrode.

In an embodiment of the present application, atmospheric pressure may mean a pressure in a state in which a specific pressure is not applied or lowered, and may be used in the same sense as the atmospheric pressure. In general, it may be expressed as 1 atmosphere.

In an embodiment of the present application, there is provided a lithium secondary battery comprising: a cathode; the lithium secondary battery anode according to the present application; a separator provided between the cathode and the anode; and an electrolyte.

FIG. 2 is a diagram illustrating a laminated structure of a lithium secondary battery according to an embodiment of the present application. Specifically, a lithium secondary battery anode 100 comprising an anode active material layer 20 formed on one surface of an anode current collector layer 10 may be confirmed, a lithium secondary battery cathode 200 comprising a cathode active material layer 40 formed on one surface of a cathode current collector layer 50 may be confirmed, and it shows that the lithium secondary battery anode 100 and the lithium secondary battery cathode 200 are formed in a structure in which they are laminated with a separator 30 being interposed therebetween. Alternatively, the anode active material layer 20 may be formed on both surfaces of the anode current collector layer 10. Further, the cathode active material layer 40 may be formed on both surfaces of the cathode current collector layer 50.

In particular, a secondary battery according to an embodiment of the present specification may comprise the above-described lithium secondary battery anode. Specifically, the secondary battery may comprise an anode, a cathode, a separator interposed between the cathode and the anode, and an electrolyte, and the anode is the same as the above-described anode.

The cathode may comprise a cathode current collector and a cathode active material layer which is formed on one or both sides of the cathode current collector and contains the cathode active material.

In the cathode, the cathode current collector is not particularly limited as long as it has conductivity without causing a chemical change in the battery, and for example, stainless steel, aluminum, nickel, titanium, calcined carbon, one in which the surface of aluminum or stainless steel is surface-treated with carbon, nickel, titanium, silver, etc., or the like may be used. Further, the cathode current collector may typically have a thickness of 3 μm to 500 μm, and may increase adhesive force of the cathode active material by forming fine irregularities on the surface of the current collector. For example, it may be used in various forms such as a film, a sheet, a foil, a net, a porous body, a foam, a nonwoven fabric, etc.

The cathode active material may be a commonly used cathode active material. Specifically, the cathode active material may comprise: a layered compound such as lithium cobalt oxide (LiCoO₂), lithium nickel oxide (LiNiO₂) or the like, or a compound substituted with one or more transition metals; lithium iron oxides such as LiFe₃O₄, etc.; lithium manganese oxides of the formula Li_{1+c1}Mn_{2-c1}O₄ (0≤c1≤0.33), LiMnO₃, LiMn₂O₃, LiMnO₂, etc.; lithium copper oxide (Li₂CuO₂); vanadium oxides such as LiV₃O₈, V₂O₅, Cu₂V₂O₇, etc.; Ni site-type lithium nickel oxides represented by the formula LiNi_{1-c2}M_{c2}O₂ (where M is at least one selected from the group consisting of Co, Mn, Al, Cu, Fe, Mg, B and Ga, and satisfies 0.01≤c2≤0.3); lithium-manganese composite oxides represented by the formula LiMn_{2-c3}M_{c3}O₂ (where, M is at least one selected from the group consisting of Co, Ni, Fe, Cr, Zn and Ta, and satisfies 0.01≤c3≤0.1) or Li₂Mn₃MO₈ (where, M is at least one selected from the group consisting of Fe, Co, Ni, Cu, and Zn); LiMn₂O₄ in which a part of Li in the formula is substituted with an alkaline earth metal ion; etc., but the present disclosure is not limited thereto. The cathode may be Li-metal.

The cathode active material layer may contain a cathode conductive material and a cathode binder together with the above-described cathode active material.

At this time, the cathode conductive material is one which is used to impart conductivity to the electrode, and in a battery to be configured, a cathode conductive material may be used without any particular limitation as long as it has electronic conductivity without causing a chemical change. Specific examples of the cathode conductive material may comprise: graphite such as natural graphite, artificial graphite, or the like; carbon-containing materials such as carbon black, acetylene black, ketjen black, channel black, furnace black, lamp black, thermal black, carbon fiber, etc.; metal powders or metal fibers of copper, nickel, aluminum, silver, etc.; conductive whiskers such as zinc oxide, potassium titanate, etc.; conductive metal oxides such as titanium oxide, etc.; conductive polymers such as polyphenylene derivatives, etc.; or the like, and may be used alone or in mixtures of two or more thereof.

Further, the cathode binder serves to improve adhesion between cathode active material particles and adhesive force between the cathode active material and the cathode current collector. Specific examples of the cathode binder may comprise polyvinylidene fluoride (PVDF), poly(vinylidene fluoride-hexafluoropropylene) (PVDF-co-HFP) copolymer, polyvinyl alcohol, polyacrylonitrile, carboxymethyl cellulose (CMC), starch, hydroxypropyl cellulose, regenerated cellulose, polyvinylpyrrolidone, polytetrafluoroethylene, polyethylene, polypropylene, ethylene propylene diene monomer (EPDM), sulfonated EPDM, styrene butadiene rubber (SBR), fluororubber, various copolymers thereof, or the like, and may be used alone or in mixtures of two or more thereof.

The separator is one which separates the anode and the cathode and provides a moving passage of lithium ions, and as long as it is usually used as a separator in a secondary battery, it can be used without any particular limitation. In particular, it is preferable that the separator has excellent electrolyte moisture-containing capability while having low resistance to ion movement of the electrolyte. Specifically, a porous polymer film, for example, a porous polymer film made of polyolefin-containing polymers such as ethylene homopolymer, propylene homopolymer, ethylene/butene copolymer, ethylene/hexene copolymer, ethylene/methacrylate copolymer, etc., or a laminated structure of two or more layers thereof may be used. Further, a usual porous nonwoven fabric, for example, a nonwoven fabric made of high-melting point glass fiber, polyethylene terephthalate fiber, etc. may be used. Further, a coated separator containing a ceramic component or a polymer material may be used in order to secure heat resistance or mechanical strength, and may optionally be used in a single-layer or multilayer structure.

Examples of the electrolyte may comprise, organic liquid electrolytes, inorganic liquid electrolytes, solid polymer electrolytes, gel-type polymer electrolytes, solid inorganic electrolytes, melt-type inorganic electrolytes, etc. which can be used when manufacturing a lithium secondary battery, but the present disclosure is not limited thereto.

Specifically, the electrolyte may comprise a non-aqueous organic solvent and a metal salt.

As the non-aqueous organic solvent, for example, aprotic organic solvents such as N-methyl-2-pyrrolidinone, propylene carbonate, ethylene carbonate, butylene carbonate, dimethyl carbonate, diethyl carbonate, gamma-butyrolactone, 1,2-dimethoxyethane, tetrahydrofuran, 2-methyltetrahydrofuran, dimethyl sulfoxide, 1,3-dioxolane, formamide, dimethylformamide, dioxolane, acetonitrile, nitromethane, methyl formate, methyl acetate, phosphoric acid triester, trimethoxy methane, dioxolane derivatives, sulfolane, methyl sulfolane, 1,3-Dimethyl-2-imidazolidinone, propylene carbonate derivatives, tetrahydrofuran derivatives, ether, methyl propionate, ethyl propionate, etc. may be used.

In particular, ethylene carbonate and propylene carbonate, which are cyclic carbonates, among the carbonate-containing organic solvents, are high-viscosity organic solvents, and may be preferably used since they have a high dielectric constant and well dissociate lithium salts. If such cyclic carbonates are mixed with low-viscosity, low-dielectric constant linear carbonates such as dimethyl carbonate and diethyl carbonate at an appropriate ratio, and used, an electrolyte having high electrical conductivity may be prepared, and thus they may be used more preferably.

A lithium salt may be used as the metal salt, the lithium salt is a material that is well soluble in the non-aqueous electrolyte, and for example, one or more selected from the group consisting of F⁻, Cl⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃ (CF₂)₇SO₃⁻, CF₃CO₂⁻, CH₃CO₂⁻, SCN⁻, and (CF₃CF₂SO₂)₂N⁻ may be used as anions of the lithium salt.

In addition to the electrolyte components, for the purpose of improving the lifespan characteristics of the battery, suppressing the decrease in battery capacity, improving the discharge capacity of the battery, etc., the electrolyte may further comprise one or more additives of, for example, haloalkylene carbonate-containing compounds such as difluoroethylene carbonate and the like, pyridine, triethyl phosphite, triethanolamine, cyclic ether, ethylenediamine, n-glyme, hexaphosphoric acid triamide, nitrobenzene derivatives, sulfur, quinoneimine dye, N-substituted oxazolidinones, N,N′-substituted imidazolidines, ethylene glycol dialkyl ethers, ammonium salts, pyrrole, 2-methoxyethanol, aluminum trichloride, etc.

An embodiment of the present disclosure provides a battery module comprising the secondary battery as a unit cell and a battery pack comprising the battery module. Since the battery module and the battery pack comprise the secondary battery having high capacity, high rate performance, and cycle characteristics, they may be used as a power source for a medium-to-large sized device selected from the group consisting of an electric vehicle, a hybrid electric vehicle, a plug-in hybrid electric vehicle, and a system for power storage.

Hereinafter, preferred embodiments are presented to help the understanding of the present disclosure, but the embodiments are merely for exemplifying the present disclosure, and it will be apparent to those skilled in the art that various changes and modifications are possible within the scope and technical spirit of the present disclosure, it goes without saying that such variations and modifications fall within the scope of the appended claims.

### Preparation Example

<Preparation of Anode compositions>

Anode compositions satisfying the compositions and contents of Table 1 below were prepared respectively.

TABLE 1

| | | | | | | | Anode binder |
|---|---|---|---|---|---|---|---|
| | | | | | | | properties |
| | | | | | Anode binder | | Young's |
| | Silicon-containing | | | | Main | Secondary | modulus |
| | active material | | Anode conductive material | | binder | binder | (MPa)/ |
| | Type | Content | Type | Content | (Content) | (Content) | Strain (%) |
| Example 1 | Si | 79.5 | SWCNT/plate-shaped | 0.4/9.6 | PAM (10) | SBR-1 (0.5) | 102.9/22.1 |
| | | | conductive material A | | | | |
| Example 2 | Si | 78.75 | SWCNT/plate-shaped | 0.4/9.6 | PAM (10) | SBR-1 (1.25) | 96.0/45.0 |
| | | | conductive material A | | | | |
| Example 3 | Si | 80 | SWCNT/plate-shaped | 0.4/9.6 | PAM (9) | SBR-1 (1) | 97.2/41.0 |
| | | | conductive material A | | | | |
| Example 4 | Si | 79.5 | plate-shaped | 10 | PAM (10) | SBR-1 (0.5) | 102.9/22.1 |
| | | | conductive material A | | | | |
| Example 5 | Si | 79.5 | Carbon Black (a dot type | 10 | PAM (10) | SBR-1 (0.5) | 102.9/22.1 |
| | | | conductive material) | | | | |
| Example 6 | Si | 79.5 | SWCNT/plate-shaped | 0.4/4.8/4.8 | PAM (10) | SBR-1 (0.5) | 102.9/22.1 |
| | | | conductive material | | | | |
| | | | A/Carbon Black | | | | |
| Comparative | Si | 80 | SWCNT/plate-shaped | 0.4/9.6 | PAM (10) | — | 108.0/5.0 |
| Example 1 | | | conductive material A | | | | |
| Comparative | Si | 80 | SWCNT/plate-shaped | 0.4/9.6 | CMC (3) | SBR-1 (7) | 33.1/7.7 |
| Example 2 | | | conductive material A | | | | |
| Comparative | Si | 75 | SWCNT/plate-shaped | 0.4/9.6 | PAM (10) | SBR-1 (5) | 72.0/125.0 |
| Example 3 | | | conductive material A | | | | |
| Comparative | Si | 80 | SWCNT/plate-shaped | 0.4/9.6 | PAM (8) | SBR-2 (2) | 86.4/158.6 |
| Example 4 | | | conductive material A | | | | |
| Comparative | Si | 80 | SWCNT/plate-shaped | 0.4/9.6 | PAM (10) | SBR-2 (0.5) | 102.9/41.6 |
| Example 5 | | | conductive material A | | | | |
| Comparative | Si | 80 | SWCNT/plate-shaped | 0.4/9.6 | PAM (10) | SBR-2 (1.25) | 96.0/90.3 |
| Example 6 | | | conductive material A | | | | |
| Comparative | Si | 79.5 | SWCNT/plate-shaped | 0.4/9.6 | — | SBR-1 (10.5) | 0.1/365.0 |
| Example 7 | | | conductive material A | | | | |

In Table 1 above, the silicon-containing active material was Si (average particle diameter (D50): 3.5 μm), the plate-shaped conductive materials A had a BET specific surface area of 17 m²/g, a D10 of 1.7 μm, a D50 of 3.5 μm, and a D90 of 6.8 μm, and materials satisfying a BET specific surface area of about 1,000 to 1,500 m²/g and having an aspect ratio of 10,000 or more were used as SWCNTs.

Further, as described in Table 1 above, as the secondary binder, SBR-1, a styrene-butadiene rubber containing a butadiene component of 81%, was used, and SBR-2, a styrene-butadiene rubber containing a butadiene component of 38%, was used. The PAM (polyacrylamide) binder used as the main binder was a binder which had a PDI value of 20 to 50 by having a weight average molecular weight (Mw) of 500,000 to 800,000 g/mol and a number average molecular weight (Mn) of a 100,000 to 400,000 level.

In addition, the Young's modulus of PAM is 108 MPa (5% strain), SBR-1 has a strain value of 365% (0.1 MPa), and SBR-2 has a strain value of 773% (0.15 MPa).

In the method of measuring the Young's modulus and strain, moisture is removed by putting the main and secondary binder solutions in a coated bowl and drying them at room temperature for a long time. After that, the dried film was cut or punched into a sample form of 6 mm×100 mm to collect a sample, and measured using UTM equipment.

The Young's modulus and strain of the main and secondary binder are different according to a measurement method, a speed, and a measurement state of the binder, but the Young's modulus of the main binder is measured in a dry room having a dew point of −5° C. to 10° C. and the temperature is about 20° C. to 22° C.

The binder was in an aqueous form, and the weight average molecular weight and number average molecular weight were measured using aqueous gel permeation chromatography (GPC).

In Table 1 above, the content may mean a weight ratio (parts by weight) of each composition based on 100 parts by weight of the total anode composition.

Manufacturing of Anodes

Anode slurries were prepared by adding distilled water as a solvent for forming the anode slurry to the anode compositions having the compositions of Table 1 above (solid content concentration of 25% by weight).

Thereafter, the anode slurries were coated to a thickness of 38 μm on an 8 μm-thick Cu foil in an anode loading amount of 76.34 mg/25 cm² to form anode active material layers (anode active material layer on each side of the Cu foil), and then the anode active material layers were dried at 130° C. for 12 hours and rolled to a porosity of the anodes of 40%, thereby manufacturing the anodes.

<Manufacturing of Secondary Batteries>

Cathode slurries (solid content concentration of 78% by weight) were prepared by adding LiNi_{0.6}Co_{0.2}Mn_{0.2}O₂ (average particle diameter (D50): 15 gm) as a cathode active material, carbon black (product name: Super C65, manufacturer: Timcal) as a conductive material, and polyvinylidene fluoride (PVdF) as a binder to N-methyl-2-pyrrolidone (NMP) as a cathode slurry-forming solvent at a weight ratio of 97:1.5:1.5.

Cathodes (thickness of the cathodes: 77 μm, porosity of 26%) were manufactured by coating the cathode slurries on both surfaces of an aluminum current collector (thickness: 12 μm) as a cathode current collector in a loading amount of 537 mg/25 cm², rolling the coated cathode slurries, and drying the rolled cathode slurries in a vacuum oven at 130° C. for 10 hours, thereby forming cathode active material layers (thickness: 65 μm).

Lithium secondary batteries were manufactured by interposing a polyethylene separator between the cathodes and the anodes of Examples 1 to 6 and Comparative Examples 1 to 7 above, and injecting an electrolyte.

The electrolyte was one in which 3% by weight of vinylene carbonate was added to an organic solvent having fluoroethylene carbonate (FEC) and diethyl carbonate (DMC) mixed therein at a volume ratio of 30:70 based on the total weight of the electrolyte, and LiPF₆ as a lithium salt was added to a concentration of 1M.

### Experimental Example 1: Evaluation of Electrode Adhesive Force

Adhesive force values of the manufactured anodes were evaluated. Specifically, in order to perform evaluation of adhesive force, after adhering the anode active material layers on the surface of the electrode on the slide glass to which the adhesive film was attached and measuring the adhesive strength (peel strength) values at a rate of 5 mm/s in an angular direction of 90°, the measurement results are shown in Table 2 below.

TABLE 2

| | Electrode adhesive force (gf/5 mm) |
|---|---|
| Example 1 | 363.30 |
| Example 2 | 412.90 |
| Example 3 | 331.79 |
| Example 4 | 322.4 |
| Example 5 | 291.2 |
| Example 6 | 337.9 |
| Comparative Example 1 | 287.21 |
| Comparative Example 2 | 255.73 |
| Comparative Example 3 | 419.50 |
| Comparative Example 4 | 352.60 |
| Comparative Example 5 | 339.54 |
| Comparative Example 6 | 398.41 |
| Comparative Example 7 | 312.11 |

When an excessive amount of the secondary binder, which is a rubber-containing binder, is applied compared to the main binder, which is an aqueous binder, the adhesive force increases. That is, the main binder, which is an aqueous binder, corresponds to a material having dispersibility and adhesive force together by dispersing the active material, maintaining the viscosity in the aqueous slurry state, and imparting adhesion with the anode current collector layer after drying. However, the secondary binder, which is a rubber-containing binder, corresponds to a binder having only characteristics for increasing adhesive force.

Therefore, as can be confirmed from the results of Table 2 above, it could be confirmed that the electrode adhesive forces of Examples 1 to 6 were all excellent compared to Comparative Example 1 to which only the main binder that was an aqueous binder was applied. However, only the content of the secondary binder cannot be increased unreasonably in order to increase the adhesive force.

The performance of the silicon-containing anode (especially, pure Si anode) deteriorates as increased is the number of silicon-containing active materials isolated since the network between the active materials is broken due to a high expansion/contraction ratio. Although there is a problem between the active materials, more important is the adhesive force between the active material and the anode current collector layer. If this part is disconnected, the route itself through which electrons can move disappears, which greatly affects the performance.

Therefore, the main binder having high strength rigidity rather than the secondary binder material having a low strength should be included together, and for this reason, the specific ratio of the main and secondary binders of the present disclosure is important for adhesive force and disconnection and isolation and suppression.

Table 2 above was an experiment capable of confirming that the basic anode adhesive force was excellent since Examples 1 to 6 had a certain anode adhesive force range (290 gf/5 mm) or more as results of the simple adhesive force.

In Comparative Example 1, the anode adhesive force was measured to be low since only the main binder, which was an aqueous binder, was contained so that the binder had high rigidity, but did not have high adhesive force. Comparative Example 2 corresponds to a case in which CMC, which is a type of an aqueous binder serving as a dispersant and a thickener, rather than serving as a binder, and a secondary binder are contained. In this case, the rigidity of the binder itself was weak so that, when measuring the adhesive force, an intermediate portion of the anode active material layer, not the anode active material layer and the anode current collector layer, was separated and measured so that the adhesive force was formed low. In such a case as well, it can be evaluated that the binder similarly does not easily hold the volume expansion of the anode active material.

It can be confirmed that Comparative Examples 3 to 6 above are in a range similar to Examples 1 to 6 in terms of adhesive force by containing both the main binder and the secondary binder, but this is only the viewpoint of adhesive force, and they were evaluated poorly compared to Examples 1 to 3 in the capacity retention rate and resistance increase rate to be described later.

Further, Comparative Example 7 corresponds to the case containing only the secondary binder. In this case, similarly as in Comparative Example 2, the binder itself was weak in the rigidity so that, when measuring the adhesive force, the intermediate portion of the anode active material layer, not the anode active material layer and the anode current collector layer, was separated and measured so as to be formed to a low adhesive force. In such a case as well, it could be evaluated that the binder similarly did not easily hold the volume expansion of the anode active material.

### Experimental Example 2: Mono-Cell Lifetime Evaluation

With respect to the manufactured secondary batteries, lifetime evaluation was performed using an electrochemical charger and discharger, and capacity retention rate was evaluated. The secondary batteries were 1) charged (0.33 C CC/CV charge 4.2V 0.05 C cut) and discharged (0.33 C CC discharge 3.0V cut) as the first cycle, and then 2) charged (1.0 C CC/CV charge 4.2V 0.05 C cut) and discharged (0.5 C CC discharge 3.0V cut) as the second cycle so that charging and discharging were performed from the second cycle under the conditions.

The N-th capacity retention rate was evaluated by Equation below. The results are shown in Table 3 below.

Capacity retention rate (%)={(discharge capacity in Nₜₕ cycle)/(discharge capacity in 1ₛₜ cycle)}×100

TABLE 3

| | Capacity retention rate (based on |
|---|---|
| | @200 cycle) |
| Example 1 | 88.73 |
| Example 2 | 88.07 |
| Example 3 | 86.91 |
| Example 4 | 86.15 |
| Example 5 | 86.62 |
| Example 6 | 87.41 |
| Comparative Example 1 | 85.93 |
| Comparative Example 2 | 82.24 |
| Comparative Example 3 | 85.70 |
| Comparative Example 4 | 85.83 |
| Comparative Example 5 | 84.59 |
| Comparative Example 6 | 85.71 |
| Comparative Example 7 | 68.43 |

The capacity retention rate is an experimental example for determining how much capacity is maintained according to the number of cycles. That is, it is an evaluation result according to how much silicon (Pure Si), an active material, has been isolated or pulverized in the silicon-containing anode. In the case of seeing 200 cycles as a criterion, it is a data that can confirm the rate of performance decrease due to the short circuit of the conductive network of the silicon active material.

As in Examples 1 to 6 according to the present application, when the secondary binders are present in an amount of 1 part by weight or more and 15 parts by weight or less based on the anode binders, since, while the main binders suppress the short circuit between the active materials, the secondary binders increase the adhesive force with the anode current collector layers, thereby reducing the silicon active materials that are short-circuited and isolated, it could be confirmed that the capacity retention rates were highly evaluated compared to Comparative Examples 1 to 7.

### Experimental Example 3: Evaluation of Mono-Cell Resistance Increase Rate

With respect to the manufactured secondary batteries, lifespan evaluation was performed using an electrochemical charger and discharger, and resistance measurement was performed at 200 cycles to compare the resistance values at 200 cycles with the resistance value at the initial 0 cycle and confirm the resistance increase rates.

Specifically, resistance evaluation was carried out after the lifespan evaluation 0 cycle and 200 cycles had been completed, and the secondary batteries were fully charged by first performing charging (0.33 C CC/CV charge 4.2V 0.05 C cut). After setting the charging state to 50% by performing discharging (0.33 C CC discharge, cut at 50% capacity of the charging capacity), discharging (2.5 C CC discharge, 30 s cut) was performed. Thereafter, 200 cycle lifespan evaluation was performed in the same manner, and then the same resistance evaluation was performed.

The resistance calculation was calculated according to Equation below, and the measured results before lifespan evaluation were respectively calculated on the basis of 0 cycle to confirm the resistance value and the resistance increase rate, and the results are shown in Table 4 below.

Resistance (R)=(voltage (V) at rest state before 2.5 C discharging−voltage(V) after 30 s discharging)/discharging current (A)

Resistance increase rate (%)={(resistance at 200th cycle)/(resistance at first cycle)−1}×100

TABLE 4

| | Resistance | Resistance | Resistance |
|---|---|---|---|
| | (0 cycle, mohm) | (200 cycle, mohm) | increase rate |
| Example 1 | 0.69521 | 0.79953 | 15.0 |
| Example 2 | 0.70923 | 0.82906 | 16.9 |
| Example 3 | 0.71248 | 0.87542 | 22.9 |
| Example 4 | 0.71781 | 0.86711 | 20.8 |
| Example 5 | 0.71279 | 0.85178 | 19.5 |
| Example 6 | 0.70324 | 0.82771 | 17.7 |
| Comparative Example 1 | 0.76191 | 0.97861 | 28.4 |
| Comparative Example 2 | 0.77993 | 1.14937 | 47.4 |
| Comparative Example 3 | 0.70450 | 0.89213 | 26.4 |
| Comparative Example 4 | 0.75859 | 0.96876 | 45.9 |
| Comparative Example 5 | 0.76241 | 1.10245 | 44.6 |
| Comparative Example 6 | 0.77218 | 1.17521 | 52.2 |
| Comparative Example 7 | 0.98145 | 1.42858 | 45.6 |

The binder according to the present application contains a main binder and a secondary binder at a predetermined ratio, and in particular, the secondary binder comprises 80 parts by weight or more of butadiene.

As can be seen in Table 4 above, it can be confirmed that Examples 1 to 6 according to the present application have low resistance increase rates. Meanwhile, in the case of Comparative Examples 1 to 7, it can be confirmed that the resistance increase rates are formed to be higher than those of Examples 1 to 3 of the present disclosure.

As a result, when confirming the results of Experimental Examples 1 to 3 above, Examples 1 to 6 comprising the binder according to the present disclosure had excellent adhesive forces between the anode active material layers and the anode current collector layers, and furthermore had excellent capacity retention rates and resistance increase rates compared to Comparative Examples 1 to 7 above. In particular, when comparing Examples 1 to 6, when the planar conductive material and the linear conductive material are included (Examples 1-3), the number of connections enabling charging and discharging increases so that the output characteristics are excellent at a high C-rate and characteristics of reducing the amount of high-temperature gas generation are obtained.

This can be seen as effects of containing the main binder and the secondary binder at a specific ratio as the binder according to the present disclosure and at the same time using butadiene (BD) units in an amount of 80 parts by weight or more of the secondary binder.

### REFERENCE NUMERALS

10: Anode Current Collector Layer
20: Anode Active Material Layer
30: Separator
40: Cathode Active Material Layer
50: Cathode Current Collector Layer
100: Lithium Secondary Battery Anode
200: Lithium Secondary Battery Cathode

What is claimed is:

1. An anode composition comprising:
a silicon-containing active material;
an anode conductive material; and
an anode binder,
wherein the anode binder comprises (a) a main binder comprising an aqueous binder and (b) a secondary binder comprising a rubber-containing binder,
the anode binder contains 80 parts by weight or more and 99 parts by weight or less of the main binder and 1 part by weight or more and 20 parts by weight or less of the secondary binder containing on 100 parts by weight of the anode binder, and
the secondary binder comprises 80 parts by weight or more of butadiene (BD) units based on 100 parts by weight of the secondary binder.

2. The anode composition of claim 1, wherein the silicon-containing active material is present in an amount of 60 parts by weight or more based on 100 parts by weight of the anode composition.

3. The anode composition of claim 1, wherein the silicon-containing active material comprises one or more selected from the group consisting of SiOₓ, wherein x=0, SiOₓ, wherein 0<x<2, SiC, and an Si alloy.

4. The anode composition of claim 1, wherein the silicon-containing active material comprises one or more selected from the group consisting of SiOₓ, wherein x=0 and SiOₓ, wherein 0<x<2, and
wherein SiOₓ, wherein x=0 is present in an amount of 70 parts by weight or more based on 100 parts by weight of the silicon-containing active material.

5. The anode composition of claim 1, wherein the anode conductive material is present in an amount of 10 parts by weight or more and 40 parts by weight or less based on 100 parts by weight of the anode composition.

6. The anode composition of claim 1, wherein the anode conductive material comprises one or more of a planar conductive material, or a linear conductive material.

7. The anode composition of claim 6, wherein the anode conductive material comprises 80 parts by weight or more and 99.9 parts by weight or less of the planar conductive material and 0.1 parts by weight or more and 20 parts by weight or less of the linear conductive material based on 100 parts by weight of the anode conductive material.

8. The anode composition of claim 7, wherein the anode binder is present in an amount of 5 parts by weight or more and 30 parts by weight or less based on 100 parts by weight of the anode composition.

9. The anode composition of claim 1, wherein the main binder has a weight average molecular weight of 100,000 g/mol or more and 1,000,000 g/mol or less.

10. A lithium secondary battery anode comprising:
an anode current collector layer; and
an anode active material layer comprising the anode composition according to claim 1 on one or both surfaces of the anode current collector layer.

11. The lithium secondary battery anode of claim 10, wherein a surface of the anode active material layer in contact with the anode current collector layer satisfies an adhesive force of 300 gf/5 mm or more and 500 gf/5 mm or less under atmospheric pressure condition at 25° C.

12. The lithium secondary battery anode of claim 10, wherein the anode current collector layer has a thickness of 1 μm or more and 100 μm or less, and the anode active material layer has a thickness of 20 μm or more and 500 μm or less.

13. A lithium secondary battery comprising:
a cathode;
the lithium secondary battery anode according to claim 10;
a separator provided between the cathode and the anode; and
an electrolyte.

14. The anode composition of claim 1, wherein the aqueous binder comprises at least one selected from the group consisting of polyvinyl alcohol, polyacrylic acid, polyethylene glycol, polyacrylonitrile, and polyacrylamide.

15. The anode composition of claim 1, wherein the rubber-containing binder comprises at least one selected from the group consisting of styrene butadiene rubber, hydrogenated nitrile butadiene rubber, acrylonitrile butadiene rubber, acrylic rubber, butyl rubber, and fluororubber.
